(19) United States
(12) Patent Application Publication
(10) Pub. No.: US 2020/0049928 A1
(43) Pub. Date: Feb. 13, 2020

(54) LENS MODULE

(71) Applicant: AAC Technologies Pte. Ltd., Singapore city (SG)

(72) Inventor: Chuandong Wei, Shenzhen (CN)

(21) Appl. No.: 16/530,992

(22) Filed: Aug. 2, 2019

(30) Foreign Application Priority Data
Aug. 10, 2018 (CN) 201821302245.X

(51) Int. Cl. G02B 7/02; G02B 5/00

(52) U.S. Cl. CPC G02B 7/021; G02B 5/003

(57) ABSTRACT

The present disclosure provides a lens module. The lens module includes a lens barrel, and a lens group, a light-shielding plate and a first light-shielding sheet accommodated in the lens barrel, where the lens barrel includes a first barrel wall provided with an optical aperture, a second barrel wall bent and extending from the first barrel wall, a third barrel wall extending from the second barrel wall toward a direction away from an optical axis, and a fourth barrel wall bent and extending from the third barrel wall toward a direction away from the first barrel wall. Compared with the related art, the lens module of the present disclosure has better mechanical stability.

### TECHNICAL FIELD

The present disclosure relate to the technical field of camera lens, more particular to a lens module.

### BACKGROUND

With a continuous development of technologies, electronic devices are constantly moving toward intelligence development. In addition to digital cameras, portable electronic devices, such as tablet computers and mobile phones, are also equipped with lens modules. In order to meet people's use needs, higher requirements are raised on image quality of object captured by using the lens modules. The image quality of captured object is greatly related to stability between lenses in the lens module.

A lens module in the related art includes a lens barrel, and a lens group and a light-shielding plate accommodated in the lens barrel, where the lens barrel includes a first barrel wall extending horizontally and a second barrel wall bent and extending from the first barrel wall, the light-shielding plate includes a body portion and an extending portion extending from the body portion toward a direction of an optical axis, and the extending portion abuts against and is in contact with the second barrel wall. During assembly of the lens module, because strength of the light-shielding plate is insufficient, a gap between lenses apparently changes, which is not stable enough.

Therefore, it is necessary to provide a novel lens module to overcome the foregoing disadvantages.

### BRIEF DESCRIPTION OF THE DRAWINGS

To describe the technical solutions in the embodiments of the present disclosure more clearly, the following will briefly introduce the accompanying drawings used in the description of embodiments. Apparently, the accompanying drawings in the following description show merely some embodiments of the present disclosure, and a person of ordinary skill in the art may still derive other drawings from these accompanying drawings without creative efforts.

FIG. 1 is an entire structural diagram of a lens module according to the present disclosure;

FIG. 2 is a cross-sectional view of the lens module shown in FIG. 1 along an A-A line;

FIG. 3 is a partially exploded view of a structure of a lens module according to Embodiment 1; and

FIG. 4 is a partially exploded view of a structure of a lens module according to Embodiment 2.

### DETAILED DESCRIPTION

The following will clearly and completely describe the technical solutions in the embodiments of the present disclosure with reference to the accompanying drawings in the embodiments of the present disclosure. Apparently, the described embodiments are merely some but not all of the embodiments of the present disclosure. All other embodiments obtained by a person skilled in the art based on the embodiments of the present disclosure without creative efforts shall fall within the protection scope of the present disclosure.

### Embodiment 1

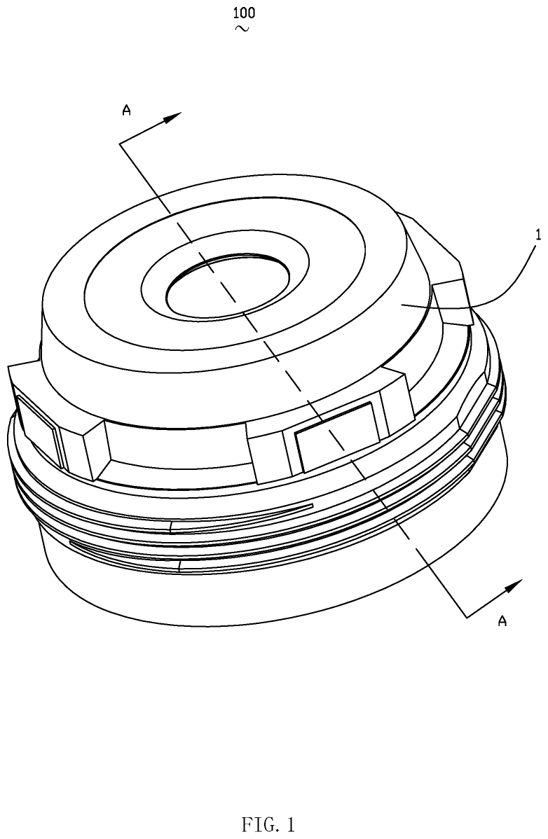

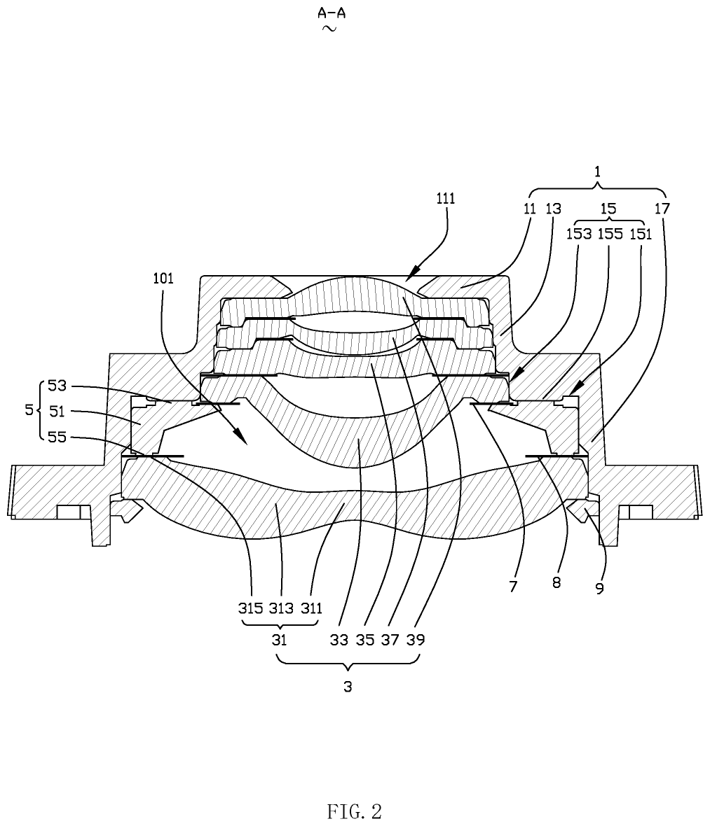

Refer to FIG. 1 and FIG. 2 together, a lens module 100 includes a lens barrel 1, and a lens group 3, a light-shielding plate 5, a first light-shielding sheet 7, a second light-shielding sheet 8, and a press ring 9 accommodated in the lens barrel 1.

The lens barrel 1 includes a first barrel wall 11 provided with an optical aperture 111, a second barrel wall 13 bent and extending from the first barrel wall 11, a third barrel wall 15 extending from the second barrel wall 13 toward a direction away from an optical axis, and a fourth barrel wall 17 bent and extending from the third barrel wall 15 toward a direction away from the first barrel wall 11. The first barrel wall 11, the second barrel wall 13, the third barrel wall 15, and the fourth barrel wall 17 together form an accommodating space 101.

The third barrel wall 15 includes: a first surface 151 away from the first barrel wall 11, a second surface 153 opposite to the optical axis, and an abutment portion 155 extending from the first surface 151 toward a direction further away from the first barrel wall 11, where the abutment portion 155 abuts against the light-shielding plate 5.

The lens group 3 includes a first lens 31 fixed to the fourth barrel wall 17, a second lens 33 fixed to the third barrel wall 15, and a third lens 35, a fourth lens 37, and a fifth lens 39 that are sequentially sandwiched between the second lens 33 and the first barrel wall 11 along a direction from the first lens 31 to the first barrel wall 11. The light-shielding plate 5 and the first light-shielding sheet 7 are located between the first lens 31 and the second lens 33. In an implementation, the lens group 3 includes five lenses. In another implementation, two lenses or other quantity of lens may be disposed according to an actual requirement.

The first lens 31 includes an optical portion 311 used for imaging, an peripheral portion 313 extending in a manner of surrounding the optical portion 311, and a protruding portion 315 extending from the peripheral portion 313 toward a direction of approaching the first barrel wall 11.

The second lens 33 abuts against the second surface 153.

The light-shielding plate 5 is sandwiched between the first lens 31 and the second lens 33. Specifically, the light-shielding plate 5 includes a body portion 51, several first lugs 53 extending from the body portion 51 toward the third barrel wall 15, and a second lug 55 extending from the body portion 51 toward a direction away from the first barrel wall 11. A gap is provided between adjacent first lugs 53.

The body portion 51 abuts against and is in contact with a surface of the fourth barrel wall 17 close to the optical axis, to implement a fixing function.

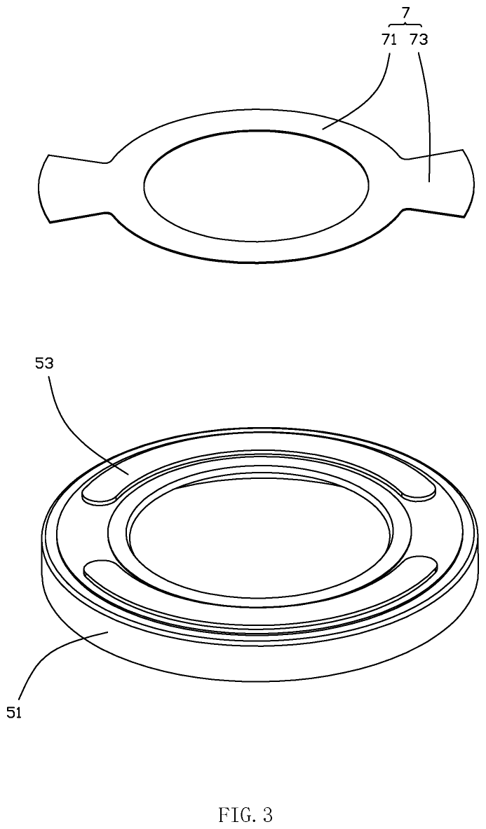

With reference to FIG. 3, in an implementation, a quantity of the first lug 53 is two, and the two first lug 53 are symmetrically disposed with respect to a central axis of the light-shielding plate 5.

A thickness of the two first lugs 53 is adjustable, and pressure on the second lens 33 is adjusted by adjusting the thickness of the first lug 53, so that the second lens 33 is stressed uniformly.

The second lug 55 is used for mounting the first lens 31. Specifically, the second lug 55 and the protruding portion 315 are disposed opposite to each other, and the second light-shielding sheet 8 is sandwiched between the second lug 55 and the protruding portion 315.

The first light-shielding sheet 7 includes a main body portion 71 and several connecting portions 73 extending outward from the main body portion 71. The main body portion 71 of the first light-shielding sheet 7 is sandwiched between the light-shielding plate 5 and the second lens 33. In addition, the connecting portions 73 are located inside the gaps between adjacent first lugs 53 and correspond to the gaps one by one.

Specifically, in an implementation, a quantity of the connecting portion 73 is two, and the two connecting portions 73 each are engaged inside a gap between the two first lug 53.

Preferably, a width of the connecting portion 73 is gradually increased from an end of the connecting portion 73 close to the optical axis to another end thereof away from the optical axis.

It should be noted that the light-shielding plate 5, the first light-shielding sheet 7, and the second light-shielding sheet 8 are all light-shielding parts, and functions of the three are basically the same. The light-shielding plate 5, the first light-shielding sheet 7, and the second light-shielding sheet 8, on the one hand, are used to concentrate dispersed light rays, and on the other hand, ensure that during assembly of the lens group 3, adjacent lenses would not be damaged because of direct contact.

The press ring 9 is disposed in an image side direction of the first lens 31. Specifically, the press ring 9 supports an image side face fixed to the peripheral portion 313.

The press ring 9 may fasten the first lens 31, the light-shielding plate 5, the first light-shielding sheet 7, and the second light-shielding sheet 8, stabilizes an internal structure of the lens module 100. The optical axis of the lens group 3 and the central axis of the lens barrel 1 are located on a same straight line. That is, a structure including the lens barrel 1 and the lens group 3 is a symmetric structure.

### Embodiment 2

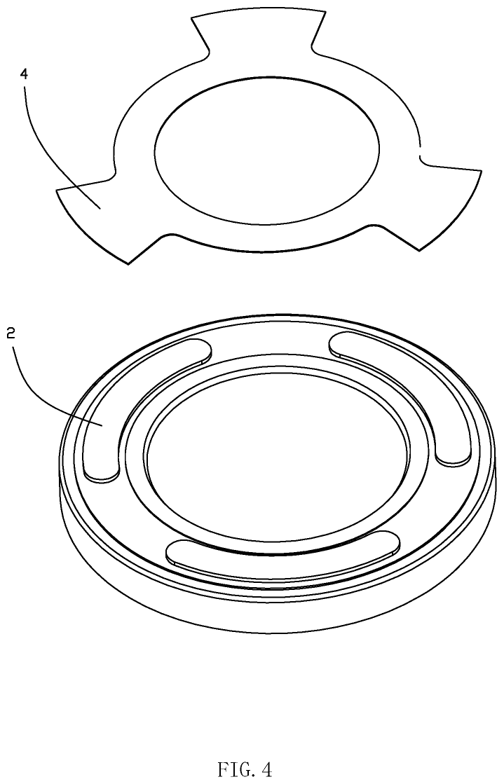

With reference to FIG. 4, a structure of a lens module provided in an embodiment is basically the same as that of the lens module 100 provided in Embodiment 1, and a difference is that a quantity of the first lug 2 is three, and the three first lugs 2 are evenly distributed along a circumferential direction of the light-shielding plate. Correspondingly, a quantity of the connecting portion 4 is also three, and the three connecting portions 4 each are engaged inside a gap between adjacent first lugs 2.

It should be noted that in the present disclosure, the quantities of the first lug and the connecting portion are not limited. Embodiment 1 and Embodiment 2 are merely two examples for convenience of description. The quantities of the first lug and the connecting portion may be set to be greater according to an actual requirement.

Compared with the related art, in the lens module 100 provided by the present disclosure, several first lugs are disposed in a spaced manner to enable the lens module 100 to adjust a thickness of the first lug and a length of the body portion 51, thereby ensuring stability of the second lens 33. Disposing the first light-shielding sheet 7 on a side of the first lug close to an optical axis, on the one hand, enables the first light-shielding sheet 7 and the light-shielding plate 5 to cooperate with each other, thereby improving light shielding performance of the lens module 100, and on the other hand, avoids affecting the thickness of the first lug, thereby ensuring stability of the second lens 33.

The above descriptions are merely implementations of the present disclosure, and it should be noted that improvements may be made by a person of ordinary skill in the art without departing from the concept of the present disclosure, and the improvements all fall within the protection scope of the present disclosure.

What is claimed is:

1. A lens module, comprising a lens barrel, and a lens group, a light-shielding plate, and a first light-shielding sheet accommodated in the lens barrel,
the lens barrel comprises a first barrel wall provided with an optical aperture, a second barrel wall bent and extending from the first barrel wall, a third barrel wall extending from the second barrel wall toward a direction away from an optical axis, and a fourth barrel wall bent and extending from the third barrel wall toward a direction away from the first barrel wall;
the lens group comprises a first lens fixed to the fourth barrel wall and a second lens fixed to the third barrel wall, and the light-shielding plate and first light-shielding sheet are located between the first lens and the second lens, wherein the light-shielding plate comprises a body portion and several first lugs extending from the body portion toward the third barrel wall, a gap is provided between adjacent first lugs;
the first light-shielding sheet comprises a body portion and several connecting portions extending outward from the body portion, and the connecting portions are located inside the gaps and correspond to the gaps one by one.

2. The lens module according to claim 1, wherein a width of the connecting portion is gradually increased from an end of the connecting portion close to the optical axis toward an end thereof away from the optical axis.

3. The lens module according to claim 1, wherein a quantity of the first lug is two, and the two first lugs are symmetrically disposed with respect to a central axis of the light-shielding plate, a quantity of the connecting portion is two, and the two connecting portions each are connected between the two first lugs in an engaged manner.

4. The lens module according to claim 1, wherein a quantity of the first lug is three, and the three first lugs are evenly distributed along a circumferential direction of the light-shielding plate, a quantity of the connecting portion is three, and the three connecting portions each are connected between adjacent first lugs in an engaged manner.

5. The lens module according to claim 1, wherein the light-shielding plate further comprises a second lug extending from the body portion toward a direction away from the first barrel wall, and the first lens is mounted on the second lug.

6. The lens module according to claim 1, wherein the third barrel wall comprises a first surface opposite to the first lens and a second surface opposite to the optical axis, and the second lens abuts against the second surface.

7. The lens module according to claim 6, wherein the third barrel wall further comprises an abutment portion extending from the first surface toward a direction of the first lens, and the abutment portion abuts against the light-shielding plate.

8. The lens module according to claim 1, wherein a main body portion of the first light-shielding sheet is sandwiched between the second lens and the light-shielding plate.

9. The lens module according to claim 1, wherein the lens module further comprises a second light-shielding sheet sandwiched between the light-shielding plate and the first lens.
